(19) United States
(12) Patent Application Publication
(10) Pub. No.: US 2025/0388030 A1
(43) Pub. Date: Dec. 25, 2025

(54) MARKING DEVICE AND IMAGE FORMING APPARATUS

(71) Applicant: Ikumi KAZAMA, Kanagawa (JP)

(72) Inventor: Ikumi KAZAMA, Kanagawa (JP)

(21) Appl. No.: 19/243,870

(22) Filed: Jun. 20, 2025

(30) Foreign Application Priority Data
Jun. 24, 2024 (JP) 2024-101534

(51) Int. Cl. B41J 11/00; B65H 5/00; B65H 37/00; B65H 43/00

(52) U.S. Cl. CPC B41J 11/0015; B65H 5/006; B65H 37/00; B65H 43/00; B65H 2301/5111; B65H 2801/12; B65H 2801/15

(57) ABSTRACT

A marking device includes a marker conveyor, a memory, and circuitry. The marker conveyor conveys a marker in a first direction from a start timing to an end timing and places the marker on an uppermost sheet of each sheet bundles each having a predetermined number of sheets conveyed in a second direction orthogonal to the first direction and stacked on a stacking table in a third direction orthogonal to the first direction and the second direction. Each of the sheets has a width in the first direction and a length in the second direction. The memory stores the width. The circuitry acquires the width from the memory and controls the marker conveyor to delay or advance the end timing according to the width acquired from the memory.

### CROSS-REFERENCE TO RELATED APPLICATION

This patent application is based on and claims priority pursuant to 35 U.S.C. § 119(a) to Japanese Patent Application No. 2024-101534, filed on Jun. 24, 2024, in the Japan Patent Office, the entire disclosure of which is hereby incorporated by reference herein.

### BACKGROUND

### Technical Field

The present disclosure relates to a marking device and an image forming apparatus.

### Related Art

In a printing apparatus or an electrophotographic image forming apparatus, printed sheets or sheets on which images have been formed, which may be referred to simply as “sheets,” are sequentially stacked on a stacking table. A sorting device inserts a sheet-shaped sorting tape into sheet bundles including multiple sheets stacked on the stacking table such that the sorting tape projects from the edge of the stacked sheet bundles for each desired number of the sheets to indicate a specific break (partition) between the stacked sheet bundles.

The sorting tape may be referred to as a marker. Such a sorting device is referred to as a marking device in the following description.

### SUMMARY

The present disclosure described herein provides an improved marking device including a marker conveyor, a memory, and circuitry. The marker conveyor conveys a marker in a first direction from a start timing to an end timing and places the marker on an uppermost sheet of each sheet bundles each having a predetermined number of sheets conveyed in a second direction orthogonal to the first direction and stacked on a stacking table in a third direction orthogonal to the first direction and the second direction. Each of the sheets has a width in the first direction and a length in the second direction. The memory stores the width. The circuitry acquires the width from the memory and controls the marker conveyor to delay or advance the end timing according to the width acquired from the memory.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic front view of an image forming apparatus;

FIG. 2 is a schematic front view of a sheet stacking device with a holder at a standby position;

FIG. 3 is a schematic plan view of a sheet stacking device with a holder at a standby position;

FIG. 4 is a schematic view of a lift used in a sheet stacking device;

FIG. 5 is a schematic front view of a sheet stacking device with a holder into which a leading end of a sheet has been inserted by a predetermined amount;

FIG. 6 is a schematic front view of a sheet stacking device with a holder which has released a sheet;

FIG. 7 is a schematic front view of a sheet stacking device with a holder which has released a sheet of a small size;

FIG. 8 is a schematic side view of a sheet stacking device including a marking device;

FIG. 9 is a schematic front view of a sheet stacking device including a marking device;

FIGS. 10A and 10B are schematic views of a marking device;

FIG. 11A is a diagram illustrating a hardware configuration of a marking device;

FIG. 11B is a functional block diagram of a marking device;

FIG. 12 is a diagram illustrating an operation sequence of a marking device;

FIG. 13 is a diagram illustrating a marker positional relationship for explaining a marker conveyance end timing;

FIG. 14 is a flowchart of an operation of a marking device;

FIGS. 15A and 15B are schematic views of a sheet stacking device including a marking device, illustrating effects obtained by the marking device;

FIGS. 16A and 16B are schematic views of a sheet stacking device including a marking device according to a comparative example; and

FIG. 17 is a diagram illustrating an operation sequence of a marking device according to a comparative example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

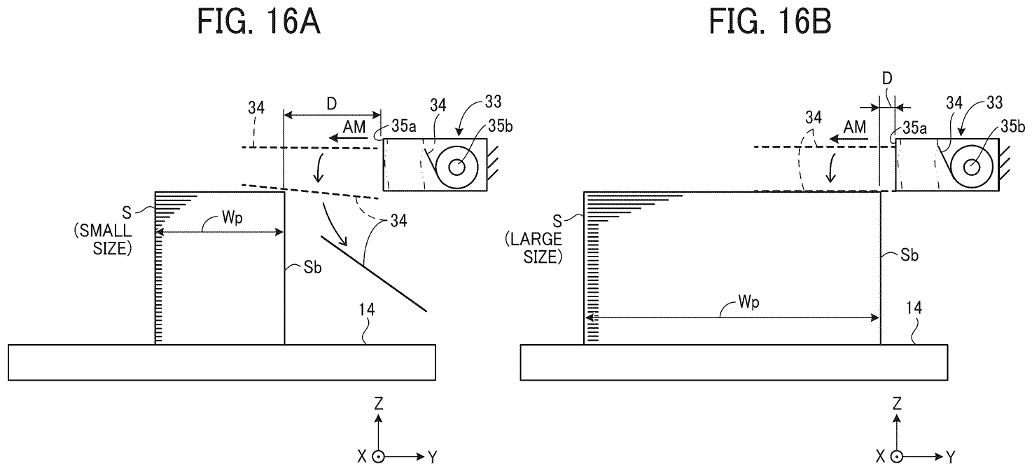

In a marking device 33, which is a position-fixed type, as illustrated in FIGS. 16A and 16B, the following situations may occur depending on a difference in sheet size (i.e., a sheet width length Wp orthogonal to a sheet conveyance length) of a sheet S stacked on a stacking table 14.

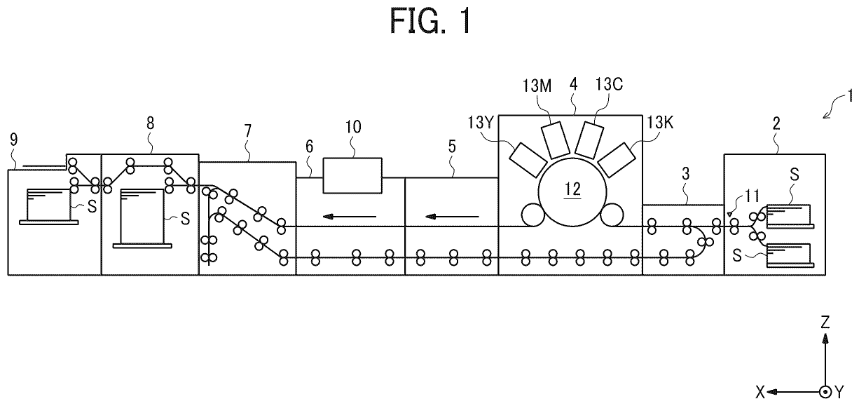

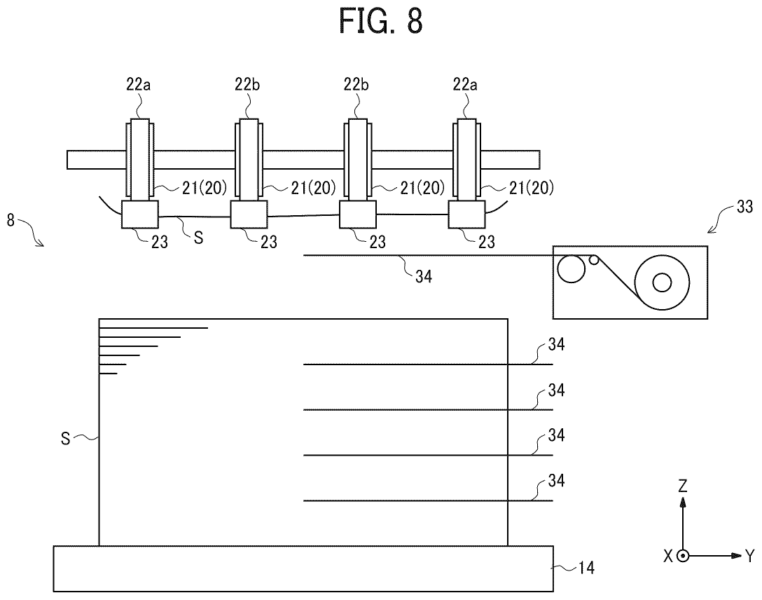

FIGS. 16A and 16B are schematic views of a sheet stacking device 8 including the marking device 33 as viewed from the downstream side in a sheet conveyance direction (i.e., a second direction). The marking device 33 is mounted in a fixed position, for example, on the outer wall, which is indicated by hatching on the right side of the marking device 33 in FIGS. 16A and 16B, of the body of the sheet stacking device 8 illustrated in FIG. 1. The sheet stacking device 8 is described later. The stacking table 14 is disposed on the left side of the marking device 33 in FIGS. 16A and 16B. Printed sheets S are stacked on the stacking table 14. The stacking table 14 is movable in a vertical direction (i.e., a third direction). The stacking table 14 is controlled so that an uppermost sheet S on the stacking table 14 occupies a certain height position, which is described in detail later. As illustrated in FIG. 8, which is described in detail later, a drive roller 20, a driven roller 21, a conveyance belt 22a, a conveyance belt 22b, and a holder 23 are disposed above the uppermost sheet S on the stacking table 14. The illustrations of the respective components described above are omitted in FIGS. 16A and 16B to explain specific situations caused by the marking device 33.

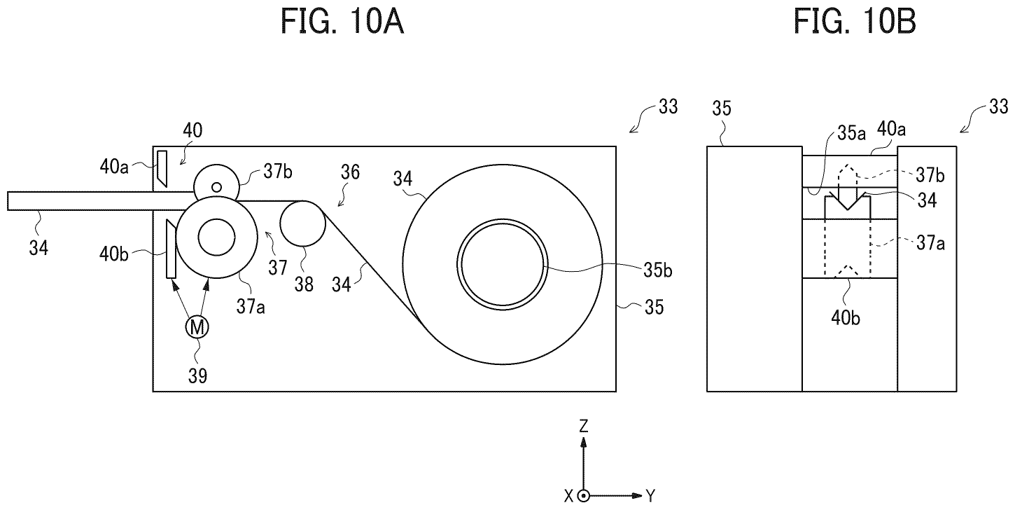

The mechanical configuration inside the marking device 33 is the same as that of the marking device 33 illustrated in FIGS. 8 and 10, which will be described later, and thus the illustrations thereof are omitted in FIGS. 16A and 16B.

First, as illustrated in FIG. 16A, the sheet width length Wp of the sheet S stacked on the stacking table 14, which may be referred to as a “stacked sheet bundle S,” is relatively smaller than the sheet width length Wp illustrated in FIG. 16B. A sheet edge Sb of the stacked sheet bundle S having the sheet width length Wp and a marker ejection port 35a of the marking device 33 are spaced apart from each other by a distance D. When the sheet width length Wp is small, the distance D becomes longer. When the marker 34, indicated by the dashed lines in FIG. 16A, is cut by a cutter 40 (see FIG. 10) of the marking device 33 and ejected from the marker ejection port 35a in a marker ejection direction (i.e., a first direction) indicated by arrow AM, the marker 34 may not be stacked on the uppermost sheet S stacked on the stacking table 14, and accordingly may fall from the uppermost sheet S and land on the stacking table 14 as indicated by the arrows in FIG. 16A. Thus, the marker 34 does not achieve the purpose of inserting the marker 34.

Secondly, as illustrated in FIG. 16B, the sheet width length Wp of the stacked sheet bundle S stacked on the stacking table 14 is relatively larger than the sheet width length Wp illustrated in FIG. 16A. As described above, the sheet edge Sb of the stacked sheet bundle S having the sheet width length Wp and the marker ejection port 35a of the marking device 33 are spaced apart from each other by the distance D. When the sheet width length Wp is long, the distance D becomes smaller. As a result, the marking device 33 ejects and outputs the marker 34 as indicated by the dashed lines in FIG. 16B. In this case, as indicated by the dashed lines in FIG. 16B, the marker 34 is ejected many times longer than a desired length of the marker 34, and thus the consumption amount of the marker 34 increases.

FIG. 1 illustrates an image forming apparatus 1. In FIG. 1, the image forming apparatus 1 includes a sheet feeding device 2 that stores a sheet S as a recording medium, a sheet position correction device 3 that corrects a position of the sheet S, and an image forming device 4 that forms an image on the sheet S. In FIG. 1 and the other drawings, an X direction (i.e., the second direction) is a sheet conveyance direction, a Y direction (i.e., the first direction) is a sheet width direction orthogonal to the sheet conveyance direction (X direction), and a Z direction (i.e., the third direction) is a vertical direction (height direction) orthogonal to the sheet conveyance direction (X direction) and the sheet width direction (Y direction).

The image forming apparatus 1 further includes a sheet drying device 5 that dries an image formed on the sheet S, a sheet cooling device 6 that cools the sheet S, a sheet reverse device 7 that reverses the sheet S, a first sheet stacking device 8 and a second sheet stacking device 9 that stack the sheet S, and a control panel 10 that controls the above-described devices based on an instruction of a user.

The sheet feeding device 2 and the sheet position correction device 3 convey the sheets S stacked and stored in the sheet feeding device 2 one by one. The sheet feeding device 2 includes a sheet size detection sensor 11 that detects the size of the sheet S to be fed. Specifically, the sheet feeding device 2 includes multiple sheet size detection sensors 11 that detect the length and width of the sheet S.

The sheet position correction device 3 adjusts the conveyance timing of the sheet S so that the image forming device 4 forms an image at a predetermined position of the sheet S based on size data of the sheet S transmitted from the sheet size detection sensor 11.

The image forming device 4 is an inkjet recording device that discharges ink of each color of black (K), cyan (C), magenta (M), and yellow (Y) onto the sheet S to form a full-color image on the sheet S. The image forming device 4 includes liquid discharge devices 13K, 13C, 13M, and 13Y that discharge the above-described inks of the respective colors. The liquid discharge devices 13K, 13C, 13M, and 13Y are disposed around a drum roll 12 to form an inkjet image of each color on the sheet S.

The sheet drying device 5 and the sheet cooling device 6 dry and then cool the inkjet image formed on the sheet S. As a result, the inkjet image is held stably on the sheet S.

The sheet reverse device 7 reverses the sheet S by a switchback manner and conveys the sheet S to the sheet position correction device 3 again, if desired, to switch the image forming surface of the sheet S that faces the drum roll 12 from the front side to the back side of the sheet S. The above-described respective devices are appropriately controlled in accordance with a user's operation via the control panel 10 to form an inkjet image on the sheet S.

The inkjet printer that forms an inkjet image has been described as the image forming apparatus 1, but an image forming apparatus is not limited thereto, and may include an electrophotographic image forming unit as the image forming device 4. In this case, the image forming apparatus may include a fixing device that fixes a toner image on the sheet S in place of the sheet drying device 5 and the sheet cooling device 6. Such an image forming apparatus may include components having the same or similar configuration as a typical image forming apparatus, and detailed descriptions thereof will be omitted.

The first sheet stacking device 8 will be described below. The first sheet stacking device 8 and the second sheet stacking device 9 are both ejection destinations to which the sheet S is ejected in the image forming apparatus 1, and may have the same configuration or different configurations. In the following description, the first sheet stacking device 8 and the second sheet stacking device 9 are not different in configuration, and are different only in the ejection destination of the sheet S.

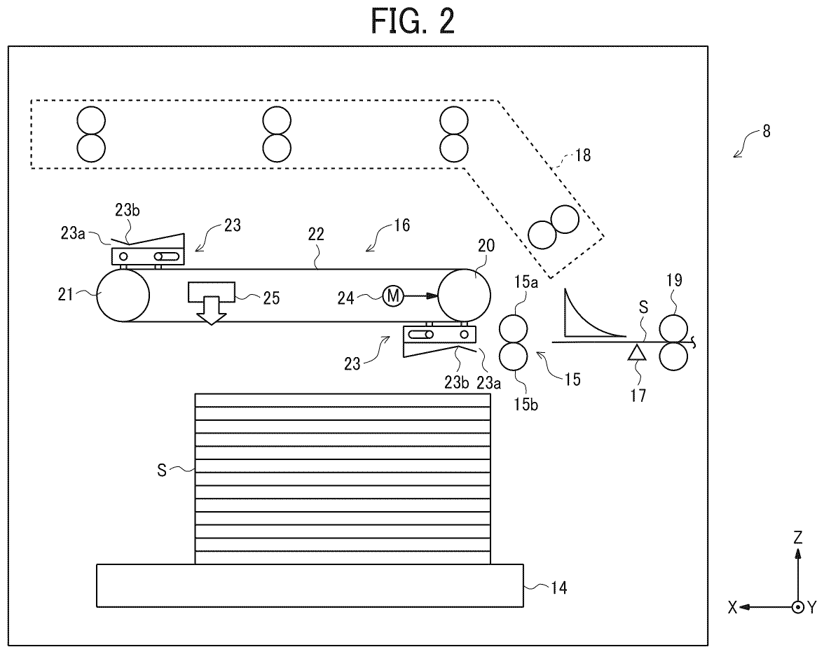

The first sheet stacking device 8 illustrated in FIG. 2 includes a stacking table 14, a sheet conveyance mechanism 15, and a guide mechanism 16. The stacking table 14 may be referred to as a sheet tray. The sheet conveyance mechanism 15 conveys the sheet S to the stacking table 14. The guide mechanism 16 grips a leading end of the sheet S conveyed toward the stacking table 14 and conveys the sheet S to a downstream side in a sheet conveyance direction. The first sheet stacking device 8 further includes a trigger sensor 17 serving as a sheet leading end detection sensor that detects the leading end of the sheet S on the upstream side of the sheet conveyance mechanism 15 in the sheet conveyance direction. The first sheet stacking device 8 further includes a bypass conveyance path 18 that conveys the conveyed sheet S to the second sheet stacking device 9 disposed on a downstream side of the first sheet stacking device 8 in the sheet conveyance direction by bypassing the stacking table 14.

After image formation, the sheet S is stacked on the stacking table 14. An initial position of the stacking table 14 is located below the sheet S fed by the sheet conveyance mechanism 15. The stacking table 14 moves downward as the sheet S is stacked on the stacking table 14, and the position of the uppermost surface of a bundle of the sheets S (i.e., a sheet bundle) stacked on the stacking table 14 is continuously maintained at a height at which the sheet S is ejected from the sheet conveyance mechanism 15 and smoothly stacked onto the uppermost surface of the sheet bundle on the stacking table 14. A lift that raises and lowers the stacking table 14 will be described later. A user pulls out the stacking table 14 from the first sheet stacking device 8 to take out the sheets S stacked on the stacking table 14.

The sheet conveyance mechanism 15 as a conveyor includes a typical roller pair including a drive roller 15a and a driven roller 15b to convey the sheet S conveyed from the image forming device 4 toward the stacking table 14. The sheet conveyance mechanism 15 receives the sheet S ejected by a supply roller pair 19 disposed at the most upstream position in the sheet conveyance direction in the first sheet stacking device 8, and conveys the sheet S to the downstream side in the sheet conveyance direction.

The trigger sensor 17 is disposed on the upstream side of the sheet conveyance mechanism 15 in a conveyance path in the sheet conveyance direction, and detects the leading end of the conveyed sheet S to output a signal.

The guide mechanism 16 is disposed on the downstream side of the sheet conveyance mechanism 15 in the sheet conveyance direction. The guide mechanism 16 conveys the sheet S in the sheet conveyance direction at a speed higher than a sheet conveyance speed of the sheet conveyance mechanism 15 while holding the leading end of the sheet S conveyed by the sheet conveyance mechanism 15. The guide mechanism 16 functions as a guide device that holds the leading end of the sheet S and releases the leading end of the sheet S at a release position to guide the conveyed sheet S onto the stacking table 14.

The guide mechanism 16 includes a rotatable endless conveyance belt 22 and the holder 23. The conveyance belt 22 is looped around the drive roller 20 and the driven roller 21. The holder 23 is attached to the conveyance belt 22 and moves along with the rotation of the conveyance belt 22. The drive roller 20 is driven by a motor 24, which is a variable speed stepper motor, to rotate the conveyance belt 22 at a variable rotation speed. The position of the holder 23 on the conveyance belt 22 can be grasped based on the number of steps of the motor 24.

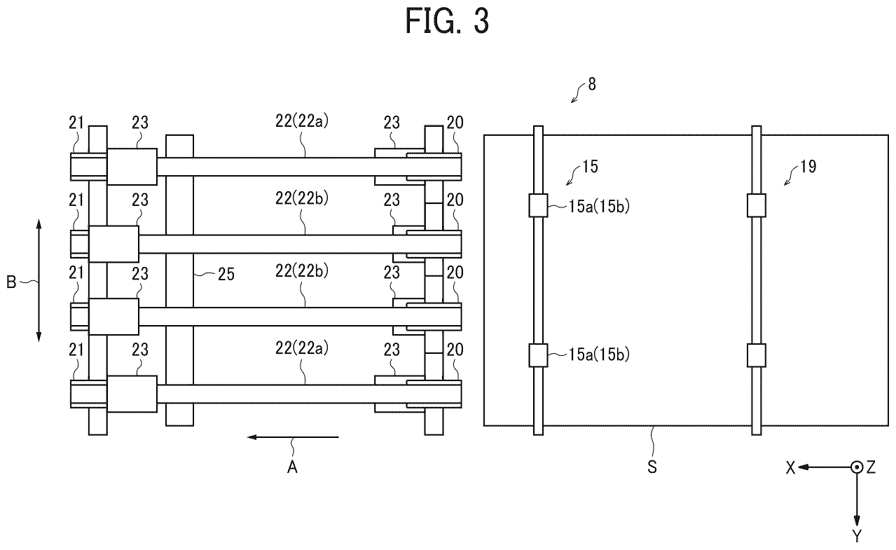

As illustrated in FIG. 3, four conveyance belts 22 (i.e., the conveyance belts 22a, 22b, 22b, and 22a) are arranged in parallel to each other in a sheet width direction of the sheet S indicated by arrow B. Two holders 23 are arranged on each of the conveyance belts 22a, 22b, 22b, and 22a at positions which are point-symmetrical to each other in the circumferential direction of the conveyance belts 22. The holder 23 is attached to the outer circumferential surface of the conveyance belt 22 and moves along with the rotation of the conveyance belt 22. In FIG. 3, the sheet S is conveyed in the sheet conveyance direction indicated by arrow A.

The first sheet stacking device 8 causes the holder 23 holding the sheet S to release the sheet S by using a speed difference between the sheet conveyance speed of the sheet conveyance mechanism 15 and the sheet conveyance speed of the guide mechanism 16. Thus, the released sheet S is stacked on the stacking table 14.

A blower fan 25 is disposed at a downstream portion of the guide mechanism 16 in the sheet conveyance direction. The blower fan 25 serves as an air blower that applies (blows) an airflow directed toward the stacking table 14, i.e., directed downward, to the conveyed sheet S. The blower fan 25 is constantly operated, and applies the airflow so as to press the sheet S held by the holder 23 against the stacking table 14.

As illustrated in FIG. 2, the holder 23 has an opening 23a into which the leading end of the sheet S is inserted, and a nipping portion 23b that nips the leading end of the sheet S inserted from the opening 23a. The force of the nipping portion 23b nipping the leading end of the sheet S is set to be smaller than the friction force between the sheet conveyance mechanism 15 and the sheet S. Thus, the nipping portion 23b allows the sheet S to enter the holder 23 stopped at a standby position illustrated in FIG. 2 by the rigidity of the sheet S conveyed by the sheet conveyance mechanism 15 and inserted from the opening 23a, and elastically holds the sheet S.

The contact face of the holder 23 with the sheet S is preferably formed of a material having high smoothness such as metal or resin. Such a material enables the holder 23 to smoothly hold the sheet S.

The holder 23 is stopped at the standby position illustrated in FIG. 2 when receiving the sheet S. The holder 23 starts conveying the sheet S at a predetermined timing after the leading end of the sheet S is detected by the trigger sensor 17 and nipped by the nipping portion 23b. As described above, the holder 23 functions as a guide that moves in the sheet conveyance direction after holding the leading end of the sheet S conveyed by the sheet conveyance mechanism 15 at the standby position to guide the conveyance of the sheet S.

In the image forming apparatus 1, as illustrated in FIGS. 2 and 3, two holders 23 are disposed on the outer circumferential surface of the conveyance belt 22 in phases different from each other by 180 degrees. Accordingly, when the conveyance of the sheet S is completed, one of the holders 23 is rotated by half as the conveyance belt 22 rotates, and the other holder 23 is positioned at the standby position and stopped. Thus, the two holders 23 are alternately moved to the standby position, so that the time until the holders 23 return to the standby position is shortened to enhance the conveyance cycle of the sheet S.

In the image forming apparatus 1, as illustrated in FIG. 3, the four conveyance belts 22 are arranged in the sheet width direction, and the two holders 23 are disposed on each of the conveyance belts 22. Accordingly, the holder 23 can be downsized as compared with one or two conveyance belts 22 each provided with two holders. As a result, the inertial load of the holder 23 when the conveyance belt 22 rotates can be reduced, and the holding posture of the sheet S can be stabilized by increasing the number of the holders 23.

The four conveyance belts 22a, 22b, 22b, and 22a are classified into end side conveyance belts 22a and 22a disposed at the respective end portions in the sheet width direction and center side conveyance belts 22b and 22b disposed between the end side conveyance belts 22a and 22a. The holders 23 are arranged so that the attaching positions in the sheet conveyance direction are different from each other between the end side conveyance belts 22a and 22a and the center side conveyance belts 22b and 22b. Specifically, the standby positions of the holders 23 on the center side conveyance belts 22b and 22b are located upstream of the standby positions of the holders 23 on the end side conveyance belts 22a and 22a in the sheet conveyance direction.

With the above configuration, the timing at which the holder 23 holds the sheet S can be shifted between the end side conveyance belts 22a and 22a and the center side conveyance belts 22b and 22b, and thus the load when the sheet S enters the holder 23 can be reduced. Further, the timing at which the holder 23 releases the sheet S is also shifted, and thus the sheet S can be kept in a stable posture.

As illustrated in FIG. 3, the sheet conveyance mechanism 15 includes two roller pairs each including the drive roller 15a and the driven roller 15b. Each roller pair has a narrow width that fits between the end side conveyance belt 22a and the center side conveyance belt 22b. In FIG. 3, the drive roller 15a is disposed on the upper surface side of the sheet S, and the driven roller 15b is disposed on the lower surface side of the sheet S, but the configuration of the drive roller 15a and the driven roller 15b is not limited thereto.

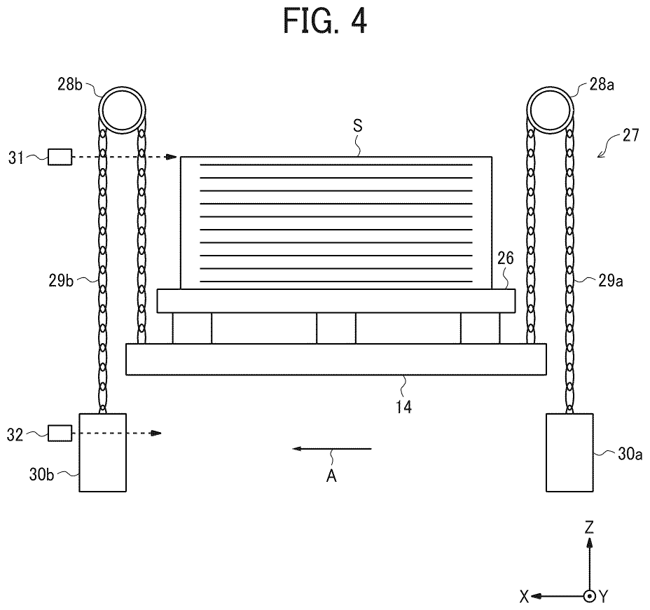

A lift that raises and lowers the stacking table 14 will be described below. As illustrated in FIG. 4, a sheet bundle of the sheets S is stacked on the stacking table 14 via a pallet 26, and the stacking table 14 can be raised and lowered by a lift 27. The lift 27 includes a pair of pulleys 28a and 28b, a pair of chains 29a and 29b, a pair of weights 30a and 30b, an upper limit detection sensor 31, and a lower limit detection sensor 32. The sheet S may be directly stacked on the stacking table 14 without using the pallet 26.

The pair of pulleys 28a and 28b are rotatably supported by a housing of the image forming apparatus 1 at positions above the stacking table 14. The pulley 28a and the pulley 28b are separated from each other in the sheet conveyance direction indicated by arrow A. The pair of chains 29a and 29b are respectively wound around the corresponding pulleys 28a and 28b, and one ends of the chains 29a and 29b are connected to the stacking table 14, and the other ends of the chains 29a and 29b are respectively connected to the corresponding weights 30a and 30b.

When the pulleys 28a and 28b rotate in a first direction (the pulley 28a rotates clockwise and the pulley 28b rotates counterclockwise in FIG. 4), the stacking table 14 moves upward and the weights 30a and 30b move downward. On the other hand, when the pulleys 28a and 28b rotate in a second direction opposite to the first direction (the pulley 28a rotates counterclockwise and the pulley 28b rotates clockwise in FIG. 4), the stacking table 14 moves downward and the weights 30a and 30b move upward.

The upper limit detection sensor 31 detects whether the uppermost sheet S stacked on the stacking table 14 reaches an upper limit position to which the sheet S is allowed to be raised by the lift 27.

The upper limit detection sensor 31 is disposed above the stacking table 14. The upper limit detection sensor 31 is, for example, a reflective optical sensor including a light emitter that outputs light and a light receiver that receives the light, which is output from the light emitter and reflected by the sheet S.

The upper limit detection sensor 31 outputs a detection signal to a controller when the sheet S is on a detection optical path of the upper limit detection sensor 31, i.e., when the uppermost sheet S stacked on the stacking table 14 reaches the upper limit position. On the other hand, the upper limit detection sensor 31 does not output the detection signal when the sheet S is not on the detection optical path. The upper limit detection sensor 31 may be a transmissive optical sensor instead of the reflective optical sensor. When the controller receives the detection signal of the upper limit position, the controller immediately stops a raising operation of the stacking table 14.

The lower limit detection sensor 32 detects whether the stacking table 14 reaches a lower limit position to which the stacking table 14 is allowed to be lowered, with the sheets S of the maximum capacity stacked on the stacking table 14. The lower limit detection sensor 32 is disposed at a position facing the weight 30b when the stacking table 14 is fully loaded. The lower limit detection sensor 32 is, for example, a reflective optical sensor similar to the upper limit detection sensor 31.

The lower limit detection sensor 32 outputs a detection signal to the controller when the stacking table 14 is on a detection optical path of the lower limit detection sensor 32, i.e., when the stacking table 14 is fully loaded and the stacking table 14 reaches the lower limit position. On the other hand, the lower limit detection sensor 32 does not output the detection signal when the stacking table 14 is not on the detection optical path. The lower limit detection sensor 32 may be a transmissive optical sensor instead of the reflective optical sensor. When the controller receives the detection signal of the lower limit position, the controller immediately stops a lowering operation of the stacking table 14.

A sheet conveyance process by the first sheet stacking device 8 described above will be described below. The stacking of the sheets S in the first sheet stacking device 8 and the stacking of the sheets S in the second sheet stacking device 9 can be achieved by like configuration and control, and thus only the first sheet stacking device 8 will be described below.

First, the first sheet stacking device 8 acquires the size data including the length of the sheet S to be conveyed and stacked. Specifically, the size data based on the length and width of the sheet S detected by the sheet size detection sensor 11 or the size data of the sheet S input by a user from the control panel 10 is used. Then, when the sheet S on which an image is formed by the sheet feeding device 2, the sheet position correction device 3, and the image forming device 4 is conveyed to the first sheet stacking device 8, the supply roller pair 19 starts conveying the sheet S, which is fed after the image is formed by the image forming device 4, and the sheet conveyance mechanism 15 is driven. At this time, the guide mechanism 16 is stopped in a standby state illustrated in FIG. 2 in which the holder 23 is stopped at the standby position, and the blower fan 25 starts blowing constantly at a constant air volume.

After that, the controller determines whether the trigger sensor 17 has detected the leading end of the sheet S. When the controller determines that the leading end of the sheet S has been detected, the controller measures a first predetermined time which is an elapsed time from a leading end detection time of the sheet S. The first predetermined time is determined in advance in accordance with the size of the sheet S to be conveyed. When the first predetermined time has elapsed, the conveyance belt 22 starts rotating, and the holder 23 that has been stopped at the standby position starts moving in the sheet conveyance direction. At this time, since the conveyance speed of the sheet S by the sheet conveyance mechanism 15 is faster than the moving speed of the holder 23, the leading end of the sheet S enters the holder 23 from the opening 23a, and the leading end that has entered the holder 23 is nipped and held by the nipping portion 23b.

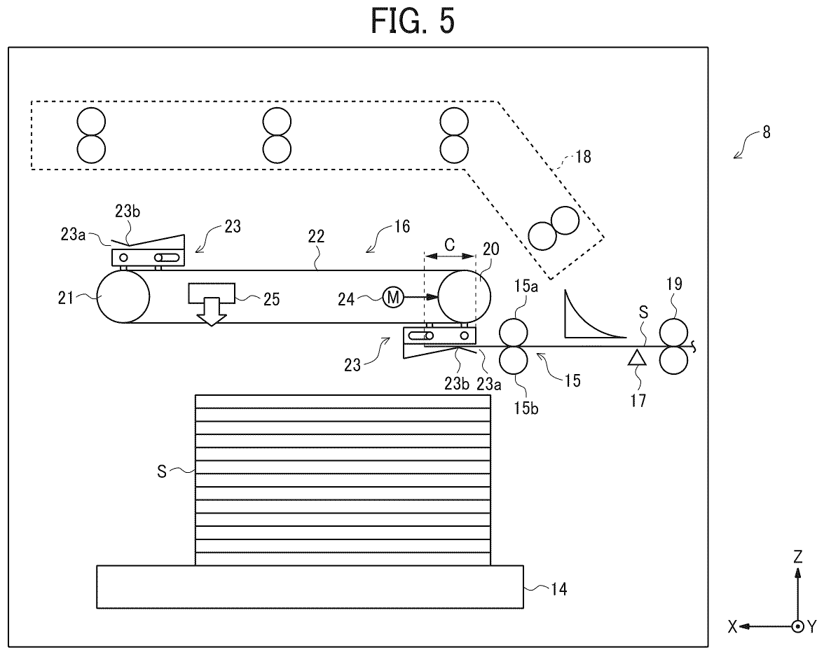

The controller controls the moving speed of the holder 23, i.e., the driving speed of the motor 24 to rotate the conveyance belt 22 so that the conveyance speed of the sheet S by the sheet conveyance mechanism 15 and the moving speed of the holder 23 are equal to each other when the sheet S has entered the holder 23. Accordingly, the leading end of the sheet S enters the holder 23 due to the speed difference until the moving speed of the holder 23 becomes equal to the conveyance speed of the sheet S by the sheet conveyance mechanism 15. The time from when the holder 23 starts moving until the sheet S has entered the holder 23 is defined as a second predetermined time. At this time, the amount of the leading end of the sheet S entering the holder 23 corresponding to the first and second predetermined times is a predetermined amount C illustrated in FIG. 5.

When the holder 23 holds the sheet S, i.e., when the amount of the leading end of the sheet S entering the holder 23 reaches the predetermined amount C, the controller accelerates the moving speed of the holder 23 (i.e., a first acceleration) and measures a third predetermined time corresponding to the size data of the sheet S acquired in advance. The sheet conveyance mechanism 15 and the guide mechanism 16 together start conveying the sheet S with the speed difference between the conveyance speed of the sheet S by the sheet conveyance mechanism 15 and the moving speed of the holder 23, which is generated by the first acceleration. At this time, the moving speed of the holder 23 becomes faster than the conveyance speed of the sheet S by the sheet conveyance mechanism 15, and the holder 23 conveys the sheet S while pulling the leading end of the sheet S. As a result, the sheet S can be prevented from bending (warping) as compared with the case of equal speeds (without the speed difference). During this conveyance, the force of the holder 23 holding the sheet S is smaller than the friction force between the sheet conveyance mechanism 15 and the sheet S. Accordingly, the sheet S is gradually drawn out from the holder 23, but the holder 23 keeps holding the sheet S from a holding position where the sheet S is held to a releasing position where the sheet S is released.

When the third predetermined time has elapsed after the holder 23 holds the sheet S, the controller accelerates the moving speed of the holder 23 (i.e., a second acceleration). As a result, the moving speed of the holder 23 is increased, and the holder 23 releases the sheet S.

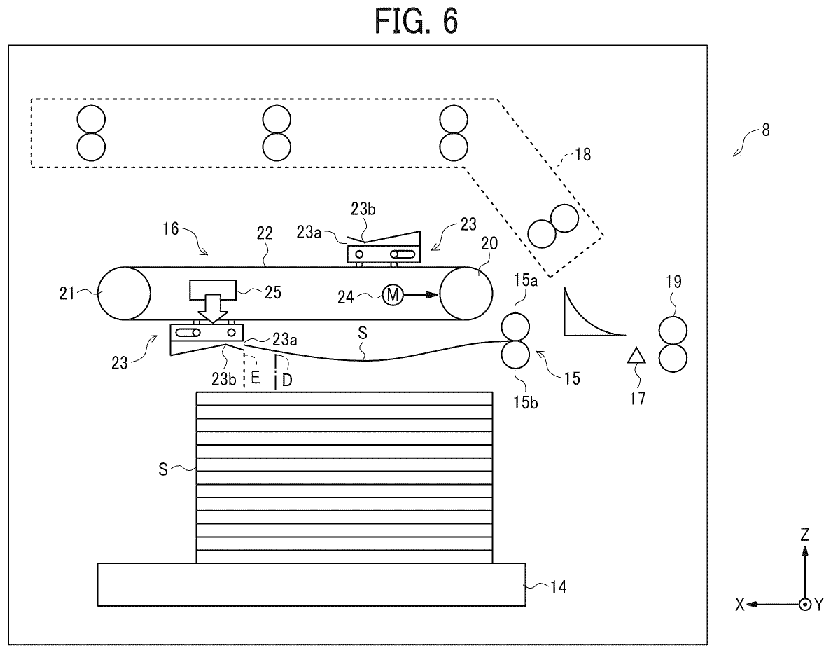

Even if the sheet S is pulled out of the sheet conveyance mechanism 15 before the sheet S is released from the holder 23, the sheet S is released from the holder 23 by the inertial force of the sheet S. FIG. 6 illustrates the sheet S released from the holder 23. In FIG. 6, the holder 23 is accelerated at an acceleration position D of the second acceleration and releases the sheet S at a release position E.

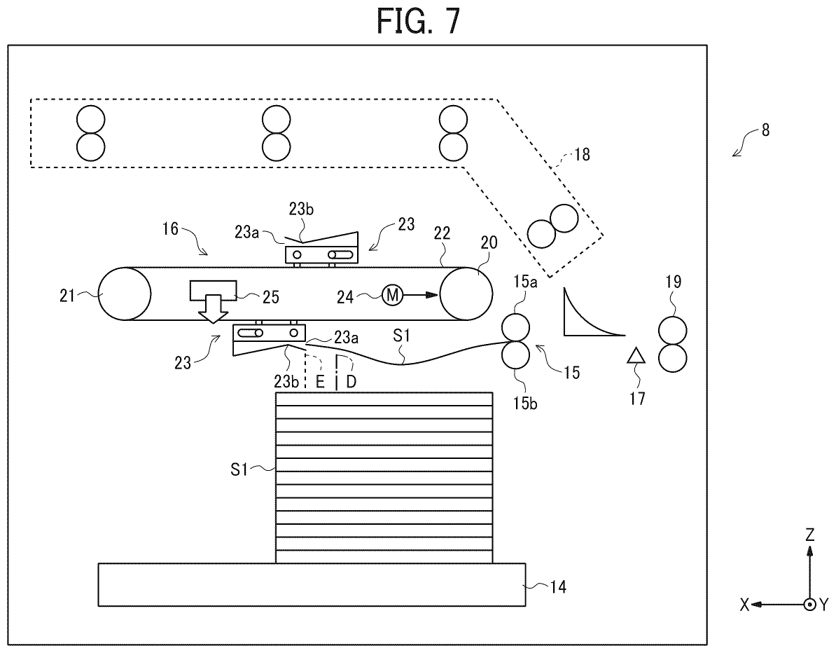

FIG. 7 illustrates a small-size sheet S1, which has a smaller size than the sheet S, used in the first sheet stacking device 8 instead of the sheet S. As illustrated in FIG. 7, the controller adjusts the acceleration position D and the release position E in accordance with the small-size sheet S1, and the small-size sheet S1 is released from the holder 23 by the speed difference between the conveyance speed of the small-size sheet S1 by the sheet conveyance mechanism 15 and the moving speed of the holder 23, which is generated by the second acceleration.

The sheet S or the small-size sheet S1 that has been pulled out of the sheet conveyance mechanism 15 and has been released from the holder 23 receives the wind force from the blower fan 25, falls toward the stacking table 14, and is stacked on the stacking table 14.

When the sheet S or the small-size sheet S1 is released from the holder 23, the controller measures a fourth predetermined time corresponding to the size data of the sheet S or the small-size sheet S1 acquired in advance. When the fourth predetermined time has elapsed, the controller starts decelerating the holder 23 and stops the holder 23 at the standby position. After that, the controller determines whether an image forming operation in the image forming device 4 is completed. When the controller determines that the image forming operation is not completed, the controller determines whether the trigger sensor 17 detects the leading end of the sheet S, and the above-described operation is repeated until the image forming operation is completed. When the controller determines that the image forming operation is completed, the controller stops the operations of the sheet conveyance mechanism 15, the guide mechanism 16, and the blower fan 25.

FIG. 8 illustrates the stacking table 14 of the first sheet stacking device 8 as viewed from the downstream side toward the upstream side in the sheet conveyance direction. In FIG. 8, the marking device 33 is disposed at a fixed position on the right side of the stacking table 14, i.e., on the front side of the image forming apparatus 1. As illustrated in FIG. 8, the marking device 33 inserts a thin sheet marker 34 as a bookmarker between sheet bundles each having the desired (predetermined) number of the sheets S stacked on the stacking table 14 such that the marker 34 projects from the sheet bundles of the sheets S to make a separator between the bundles of the desired number of the sheets S from one another.

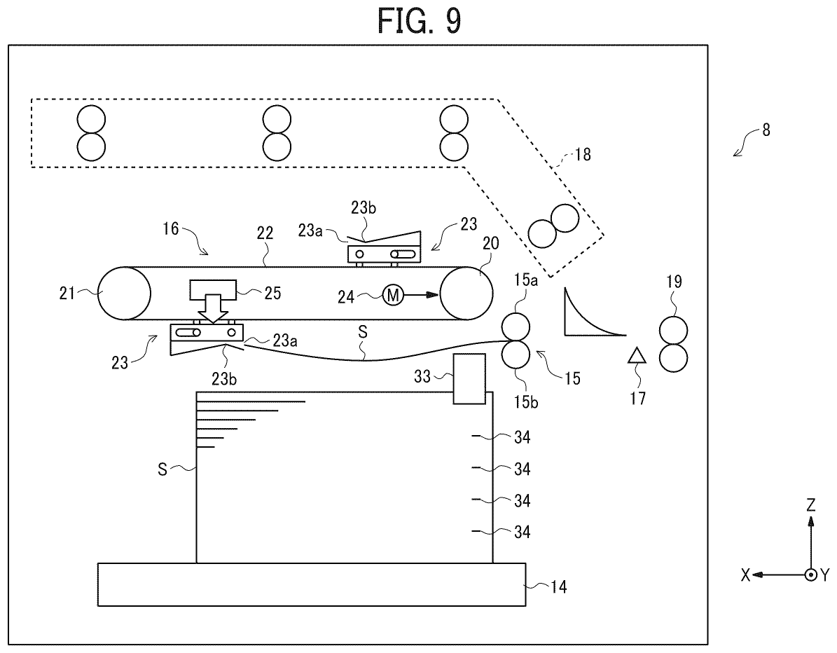

As illustrated in FIG. 9, the marking device 33 is disposed at a position near the upstream end in the sheet conveyance direction of the sheets S stacked on the stacking table 14. If the marking device 33 is disposed near the downstream end in the sheet conveyance direction of the sheets S stacked on the stacking table 14, the conveyed sheet S may not be stacked from directly above onto the stacking table 14 but may be stacked while moving at a certain speed in the sheet conveyance direction. As a result, the sheet S may move the marker 34 and drop the marker 34 from the bundle of the sheets S. The marking device 33 will be described below with reference to FIGS. 10A and 10B.

In FIGS. 10A and 10B, the marking device 33 includes a marker storage 35 that stores a continuous marker 34 wound in a roll and a marker conveyor 36 that conveys the marker 34 from the marker storage 35 toward the outside. The marker 34 is used to sort the sheets S based on image forming data set in the image forming apparatus 1. The marker 34 wound in the roll is supported by a marker spindle 35b in the marker storage 35. The marker 34 can be fed while the roll of the marker 34 rotates around the marker spindle 35b. The marker storage 35 has a sealed box shape, and has the marker ejection port 35a at one position on a side face. The marker 34 is ejected to the outside through the marker ejection port 35a.

The marker conveyor 36 includes a roller pair 37 including a drive roller 37a and a driven roller 37b that sandwich and convey the marker 34, and a tension roller 38 that applies a tensile force to the marker 34. The drive roller 37a has a V-groove on the circumferential surface and is rotationally driven by a motor 39 which is described later. The driven roller 37b has an outer shape fitted into the V-groove of the drive roller 37a and is rotated following the rotation of the drive roller 37a. The tension roller 38, which is pressed against the marker 34 by a biasing member, applies a predetermined tension to the marker 34. The tension roller 38 is also rotated following the movement of the marker 34. The marker 34 is sandwiched and conveyed by the roller pair 37. With this configuration, the marker 34 that has passed through the roller pair 37 is bent into a V-shaped cross section, and the straightness of the marker 34 is maintained without warpage or bending even after leaving the roller pair 37.

The cutter 40 is disposed between the roller pair 37 and the marker ejection port 35a to cut the marker 34 ejected through the marker ejection port 35a to the outside. The cutter 40 includes a fixed blade 40a disposed above the marker 34 passing across the cutter 40 and a movable blade 40b disposed below the marker 34 passing across the cutter 40. The movable blade 40b is moved upward by the motor 39, which is described later, and the fixed blade 40a and the movable blade 40b nip the marker 34 to cut the marker 34.

The motor 39 is disposed inside the marker storage 35. The motor 39 is shared between the drive roller 37a and the movable blade 40b to drive the drive roller 37a and the movable blade 40b. The motor 39 is rotatable forward and backward and is coupled to the drive roller 37a and the movable blade 40b via one-way clutches to drive the drive roller 37a or the movable blade 40b. The motor 39 operates in one of a forward rotation and a backward rotation to rotate the drive roller 37a, and operates in the other of the forward rotation and the backward rotation to move the movable blade 40b.

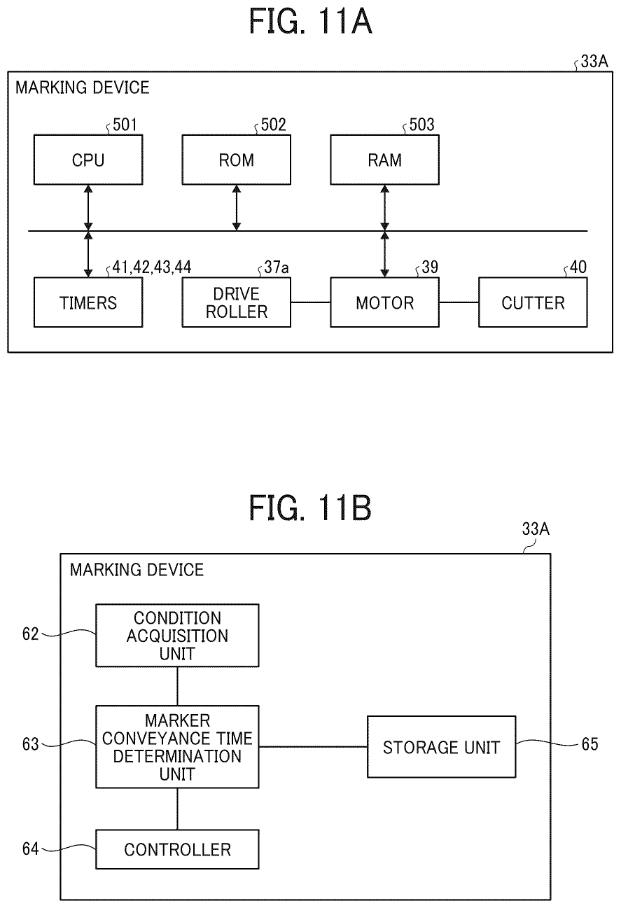

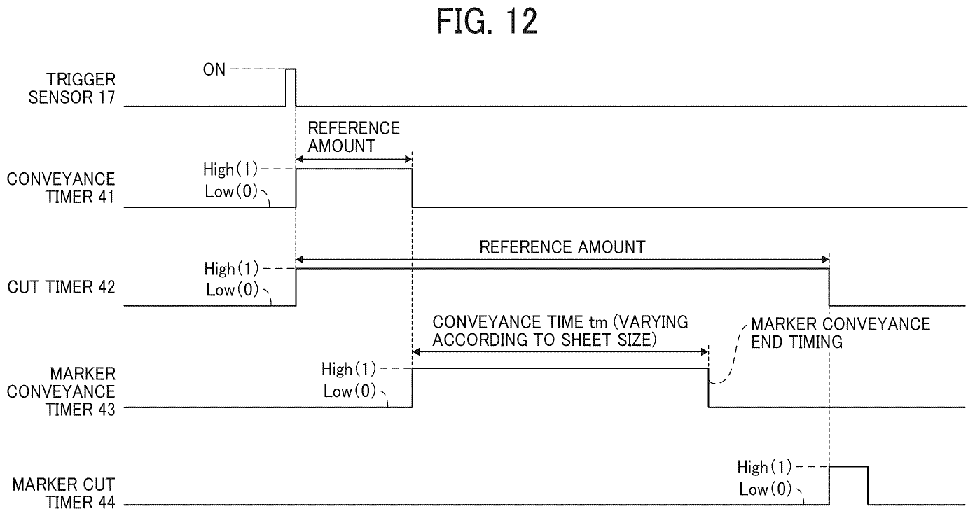

A marking device will be described below with reference to FIGS. 11A and 11B and FIG. 12. FIG. 11A is a diagram illustrating a hardware configuration of a marking device, FIG. 11B is a functional block diagram of the marking device, and FIG. 12 is a diagram illustrating an operation sequence of the marking device.

A marking device 33A illustrated in FIGS. 11A and 11B is different from the typical marking device 33 illustrated in FIGS. 8 to 10B in that a part of a control functional configuration described later is added or changed, and the mechanical configuration is the same.

As illustrated in FIG. 11A, the marking device 33A includes a central processing unit (CPU) 501, a read-only memory (ROM) 502, a random-access memory (RAM) 503, timers which will be described later, the drive roller 37a, the motor 39, and the cutter 40.

The CPU 501 is an arithmetic unit that controls the entire operation of the marking device 33A. The ROM 502 is a non-volatile storage device that stores programs, data, etc. The RAM 503 is a volatile storage device that is used as a work area of the CPU 501 and into which programs, data, etc., are loaded. The CPU 501, the ROM 502, the RAM 503, the timers, and the motor 39 are connected via buses, such as an address bus and a data bus to communicate with one another. The hardware configuration of the marking device 33A illustrated in FIG. 11 is an example, and the marking device 33A may include other components.

As illustrate in FIG. 11B, the control functional configuration of the marking device 33A includes a condition acquisition unit 62, a marker conveyance time determination unit 63, a controller 64, and a storage unit 65 as a memory.

In FIG. 11B, the condition acquisition unit 62 acquires printing conditions and acquired values acquired by the trigger sensor 17 (see FIG. 2). The marker conveyance time determination unit 63 has a function of calculating a marker conveyance time from a calculation formula based on the printing conditions and a function of reading the marker conveyance time corresponding to the printing conditions from the storage unit 65 described later. The controller 64 has a function of controlling a motor 39 used for conveying and cutting the marker 34. The storage unit 65 stores the marker conveyance time or a function used for calculating the marker conveyance time, and setting values.

For example, the condition acquisition unit 62, the marker conveyance time determination unit 63, and the controller 64 are implemented by the CPU 501 that executes the programs stored in the ROM 502, and the storage unit 65 is implemented by the ROM 502 and the RAM 503.

A control device of the marking device 33A including the condition acquisition unit 62, the marker conveyance time determination unit 63, the controller 64, and the storage unit 65 may be implemented by a microcomputer including, for example, a CPU, a RAM, a ROM, and timers.

The storage unit 65 may have a function as a sheet size data memory that stores sheet size data of the sheet S conveyed to and stacked in the first sheet stacking device 8 and the second sheet stacking device 9, in addition to the above-described function. The sheet size data includes data of a length of the sheet S in the sheet conveyance direction (i.e., sheet conveyance length data) and a width of the sheet S in a width direction orthogonal to the sheet conveyance direction (i.e., sheet width length data). The sheet size data memory may be referred to simply as a memory. Further, the storage unit 65 as the sheet size data memory may store sheet size data transmitted from various control units provided for the sheet feeding device 2 and the image forming device 3 constructing the system of the image forming apparatus 1 in FIG. 1.

The sheet width length data among the sheet size data (sheet conveyance length data and sheet width length data) is not limited thereto, and size data of the sheet S input by a user from the control panel 10 may be used.

In the marking device 33A, a marker conveyance end timing of the marker 34 fed from the marking device 33A is varied as illustrated in FIG. 12 according to the sheet width length data of the sheet size data acquired by the storage unit 65. The marker conveyance end timing may be referred to simply as an end timing.

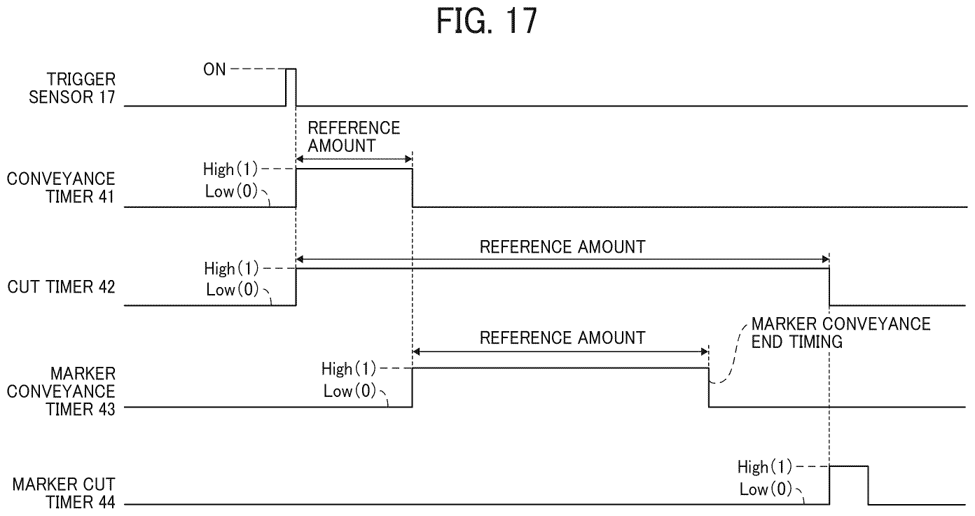

The operation sequence of the marking device 33A illustrated in FIG. 12 will be described in comparison with the operation sequence of the typical marking device 33 illustrated in FIG. 17. In FIGS. 12 and 17, the trigger sensor 17 and the timers including a conveyance timer 41, a cut timer 42, a marker conveyance timer 43, and a marker cut timer 44 are arranged vertically to describe the operation sequence.

The trigger sensor 17 (see FIGS. 2 and 9) that monitors the arrival or passage timing of the sheet S at a predetermined position is used as a start trigger, and the conveyance timer 41 and the cut timer 42 start counting in response to the detection of the trigger sensor 17, which is the same for each of the marking device 33 and the marking device 33A. On the other hand, the timing after the start of the conveyance of the marker 34 in the marker conveyance timer 43 is different between the marking device 33 and the marking device 33A, and the differences therebetween will be described later.

The cut timer 42 counts a reference amount B to start cutting the marker 34 to output the marker 34. The conveyance timer 41 illustrated in FIG. 12 secures a time from when the trigger sensor 17 detects the leading end of the sheet S to when the marking device 33 or 33A starts conveying the marker 34. As described above, the trigger sensor 17 is disposed upstream in the conveyance path to detect the leading end of the sheet S. The conveyance timer 41 indicates High (1) in a range of a reference amount A. It takes time from when the leading end of the sheet S is detected by the trigger sensor 17 to when the sheet S is ejected and stacked on the stacking table 14. For this reason, each of the marking device 33 and the marking device 33A starts conveying the marker 34 after the time set in the conveyance timer 41 has elapsed (after the sheet is reliably stacked on the stacking table 14) to reliably place the marker 34 on the sheet S ejected and stacked on the stacking table 14. The time of the conveyance timer 41 may be set according to the printing speed.

The cut timer 42 secures a time from when the trigger sensor 17 detects the leading end of the sheet S to when the cutter 40 cuts the marker 34. The cutter 40 cuts the marker 34 after the time set in the cut timer 42 has elapsed (after the leading end of the sheet S is detected by the trigger sensor 17 and the sheet S is ejected and stacked on the stacking table 14 completely) to reliably place the marker 34 on the upper surface of the sheet S stacked on the stacking table 14. The time of the cut timer 42 may be set according to the printing speed.

The marker conveyance timer 43 indicates a drive timing of the forward rotation of the motor 39 for conveying the marker 34. As described above, the motor 39 is used for both the marker conveyance and the marker cutting. The marker 34 is conveyed while the marker conveyance timer 43 indicates High (1). After the time set in the conveyance timer 41 has elapsed (i.e., the reference amount A), the marker conveyance timer 43 switches from Low (0) to High (1) and maintains High (1) for a marker conveyance time tm.

In the operation sequence of the marking device 33 illustrated in FIG. 17, the controller 64 causes (controls) the marker conveyor 36 to start conveying the marker 34 at the timing (i.e., a start timing) when the conveyance timer 41 counts the reference amount A and to stop conveying the marker 34 at the timing (i.e., the end timing) when the marker conveyance timer 43 counts a reference amount C. On the other hand, in the operation sequence of the marking device 33A illustrated in FIG. 12, the controller 64 causes the marker conveyor 36 to stop conveying the marker 34 at the timing when the marker conveyance timer 43 counts an amount corresponding to the sheet size (sheet width length). In other words, the marking device 33A is different from the marking device 33 in that the marker conveyance time tm varies, which is described later.

As described above, when the operation sequence of the marking device 33A illustrated in FIG. 12 is compared with the operation sequence of the marking device 33 illustrated in FIG. 17, the setting contents set by the marker conveyance timer 43 are different, and the other setting contents are the same.

The marker cut timer 44 indicates the drive timing of the motor 39, which is used for both the marker conveyance and the marker cutting. When the marker cut timer 44 indicates High (1), the motor 39 is rotated backward to drive the cutter 40. After the time set in the cut timer 42 has elapsed (i.e., the reference amount B), the marker cut timer 44 switches from Low (0) to High (1) and maintains High (1) to cut the marker 34.

The cut timing of the marker 34 is fixed regardless of the sheet width length. In other words, the length of the marker 34 can be controlled by controlling the marker conveyance time tm. The cut timing may be fixed regardless of the sheet width length, and may be variable depending on the printing speed. For example, the cut timing (cut timer time) in the case of a first printing speed (high-speed printing) may be earlier (smaller) than the cut timing (cut timer time) in the case of a second printing speed (low-speed printing) lower than the first printing speed.

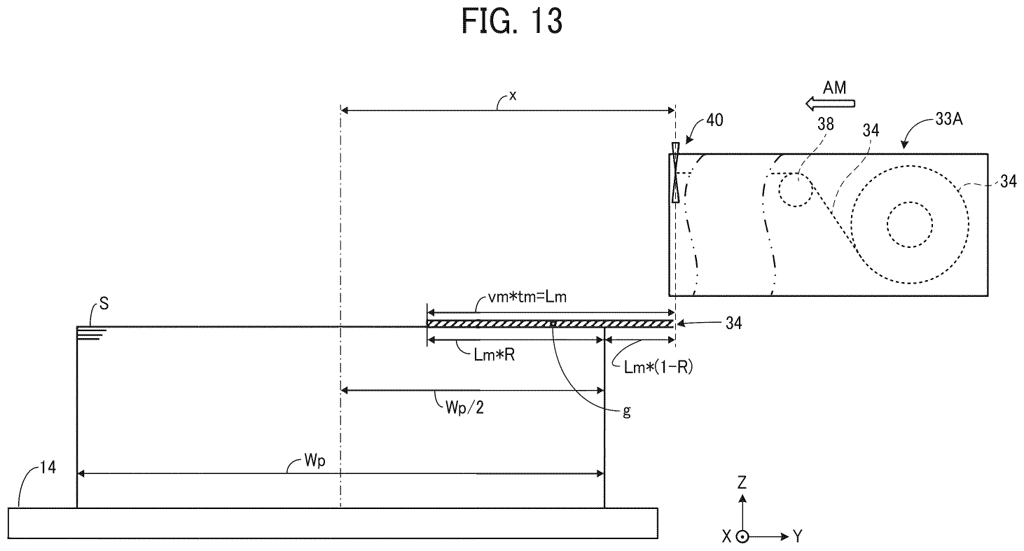

The marker conveyance end timing will be described below with reference to FIG. 13. FIG. 13 is a diagram illustrating a positional relationship of the marker 34 for explaining the marker conveyance end timing. In FIG. 13, for the sake of simplicity, the marker conveyor 36, the drive roller 37a, the driven roller 37b, and the motor 39 of the marking device 33A are omitted. In FIG. 13, the marker 34 is ejected in the marker ejection direction indicated by arrow AM. The marker ejection direction is orthogonal to the sheet conveyance direction.

The marker conveyance end timing is defined by a function of the sheet width length as described later. At this time, the center of gravity g of the marker 34, which is located at a position of a half of the length of the marker 34, is reliably placed on a sheet stacking position (position inside the area of the uppermost sheet S stacked on the stacking table 14).

The marker conveyance time tm is defined by a function of the sheet width length Wp as in Formula 1 described below.

$$tm = \frac{x - Wp / 2}{( 1 - R ) \cdot vm} \qquad Formula 1$$

In Formula 1 described above, tm represents the marker conveyance time, Wp represents the sheet width length, x represents a distance from the center of sheet conveyance to the cutter of the marking device, vm represents a marker conveyance speed, and R represents a marker stacking ratio which is a ratio of the length of a portion of the marker inside the area of an uppermost sheet of the sheet bundle stacked on the stacking table to an entire length of the marker.

According to Formula 1, the controller 64 delays the marker conveyance end timing for a longer delay time when the width of the sheets is shorter (i.e., the sheet having a first width) and advances the marker conveyance end timing for a longer advance time when the width of the sheets is longer (i.e., the sheet having a second width larger than the first width).

The sheet width length Wp is data determined by a sheet size setting included in a user setting indicating a printing condition. The image forming apparatus 1 receives the printing condition from a user. For example, the image forming apparatus 1 can store data of the sheet width length Wp for each sheet size printable by the image forming apparatus 1. The image forming apparatus 1 reads the data of the sheet width length Wp corresponding to the sheet size setting selected by the user via the control panel 10 of the image forming apparatus 1 or from an external terminal via a network, and transmits the data to the marking device 33A. However, the marking device 33A may store the data of the sheet width length Wp for each sheet size and may receive the sheet size setting selected by the user from the image forming apparatus 1 to read the data of the sheet width length Wp corresponding to the sheet size setting.

The marker conveyance speed vm can be constant regardless of the user setting, but is not limited thereto. For example, the printing speed may be determined by a printing speed setting included in the user setting received by the image forming apparatus 1 from the user. Specifically, the marker conveyance speed in the case of the first printing speed (high-speed printing) can be set to be higher than the marker conveyance speed in the case of the second printing speed (low-speed printing) lower than the first printing speed.

In this case, the image forming apparatus 1 can store data of the marker conveyance speed vm for each printing speed printable by the image forming apparatus 1. The image forming apparatus 1 reads the data of the marker conveyance speed vm according to the printing speed setting selected by the user via the control panel 10 of the image forming apparatus 1 or from an external terminal via a network, and transmits the data to the marking device 33A. However, the marking device 33A may store the data of the marker conveyance speed vm for each printing speed and may receive the printing speed setting selected by the user from the image forming apparatus 1 to read the data of the marker conveyance speed vm corresponding to the printing speed setting.

The distance x from the center of the sheet conveyance to the cutter of the marking device can be constant regardless of the user setting.

The marker stacking ratio R can be constant regardless of the user setting, but is not limited thereto. For example, the marker stacking ratio R may be determined by the sheet size setting included in the user setting received by the image forming apparatus 1 from the user. In this case, the image forming apparatus 1 can store data of the sheet stacking ratio R for each sheet size printable by the image forming apparatus 1. The image forming apparatus 1 reads the data of the sheet stacking ratio R corresponding to the sheet size setting selected by the user via the control panel 10 of the image forming apparatus 1 or from an external terminal via a network, and transmits the data to the marking device 33A.

However, the marking device 33A may store the data of the sheet stacking ratio R for each sheet size and may receive the sheet size setting selected by the user from the image forming apparatus 1 to read the data of the sheet stacking ratio R corresponding to the sheet size setting. Details of a method of determining the marker stacking ratio R according to the sheet size will be described later.

At this time, the marker stacking ratio R is set to an amount that reliably exceeds 50%. As the marker stacking ratio R increases, each of vibration and wind pressure is less likely to drop the marker 34 from the uppermost sheet of the sheet bundle, but the effect of reducing the consumption amount of the marker 34 decreases.

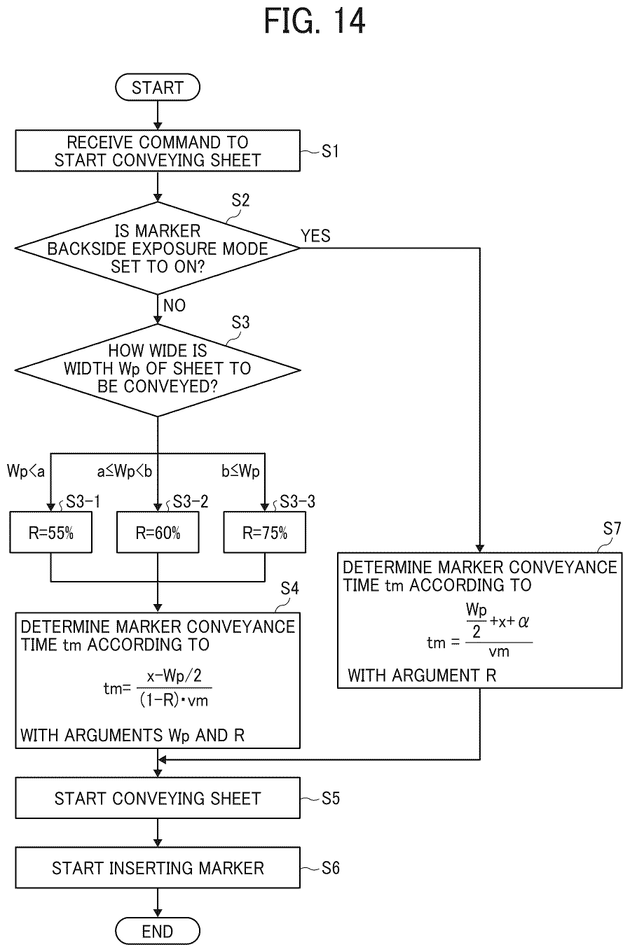

A function of finely adjusting the length of the marker 34 to place the marker 34 on the sheet bundle more reliably will be described below with reference to FIG. 14. FIG. 14 is a flowchart of an operation of the marking device 33A including a normal mode and a marker backside exposure mode different from the normal mode.

In the above description, if the length of the marker 34 calculated by Formula 1 described above is too short, the behavior of the marker 34 at the time of landing and after landing may become unstable due to, for example, the influence of the wind pressure of an internal airflow or the landing position variation caused by the air resistance. For this reason, the value of the marker stacking ratio R is variable, and the marker stacking ratio R increases with an increase in the sheet width length. In this case, the value of the marker stacking ratio R is set to 55% to 75% (see steps S3-1 to S3-3 of the flowchart of FIG. 14).

In another case, multiple patterns (groups) of the marker conveyance end timing (or the marker conveyance time) may be prepared in advance, and setting values to be applied may be allocated to ranges of the sheet width length. In other words, the setting values to be applied may be extracted from a so-called data table and allocated to the ranges of the sheet width length, respectively. In still other words, instead of calculating the marker conveyance time tm for each printing as described above, the marker conveyance time tm for each range of the sheet size can be stored in advance in the image forming apparatus 1 or the marking device 33A. Such a configuration can set the marker conveyance end timing (or the marker conveyance time) as desired without a formula.

The marker backside exposure mode in which the marker 34 projects from the opposite side of the sheet bundle stacked on the stacking table 14 will be described below. When the thickness of the sheet S is thin and the number of the markers 34 inserted into the sheet bundle is large, the thickness of the stacked sheet bundle may be locally thickened by the markers 34. As a result, for example, the upper surface of the uppermost sheet of the sheet bundle may be erroneously detected, which may cause conveyance and stacking failure.

When the marker conveyance time tm is increased, the marker 34 can extend to the opposite side of the marking device 33A as viewed from the sheet bundle. Such a function may be referred to as the marker backside exposure mode. The marker backside exposure mode can enhance the visibility of the separation position and reduce the deviation of the thickness of the stacked sheet bundle in the width direction.

Specifically, when the marker backside exposure mode is set to ON, the marker conveyance time tm is calculated by Formula 2 described below, and thus the marker 34 can be conveyed from one side of the sheet bundle (i.e., the front side of the image forming apparatus 1) where the marking device 33A is disposed with respect to the center of the stacked sheets beyond the end of the sheet bundle on the opposite side (i.e., the backside of the image forming apparatus 1). At this time, the marker 34 can be placed on the sheet bundle such that the marker 34 projects outward from the end of the sheet bundle on the opposite side by a marker exposure length a set in Formula 2.

As a user setting item of the image forming apparatus 1, for example, an on/off setting item of the marker backside exposure mode is prepared in the control panel 10 of FIG. 1. When the marker backside exposure mode is turned on, the marker conveyance time tm is calculated by Formula 2 described below.

$$tm = \frac{Wp / 2 + x + α}{vm} \qquad Formula 2$$

In Formula 2 described above, tm represents the marker conveyance time, Wp represents the sheet width length, x represents the distance from the center of sheet conveyance to the cutter of the marking device, vm represents the marker conveyance speed, and a represents a marker exposure length (desired value). In Formula 2 described above, the marker exposure length a is preferably about 20 to 30 mm.

The operation of FIG. 14 will be described below. As illustrated in FIG. 14, in step S1, the controller 64 of the image forming apparatus 1 receives a command to start conveying the sheet S. In step S2, the controller 64 determines whether the user presses an ON key of the marker backside exposure mode on the control panel 10 illustrated in FIG. 1 and the marker backside exposure mode is set to ON. If the marker backside exposure mode is not executable (not turned on) (NO in step S2), the process proceeds to step S3, and in step S3, the controller 64 determines the range of the sheet width length Wp of the sheet S to be conveyed in three levels. Specifically, in steps S3-1 to S3-3, the marker stacking ratio R of 55% is allocated to the sheet S having the sheet width length Wp smaller than a lower threshold value a (e.g., small size), the marker stacking ratio R of 60% is allocated to the sheet S having the sheet width length Wp equal to or larger than the lower threshold value a and smaller than an upper threshold value b, and the marker stacking ratio R of 75% is allocated to the sheet S having the sheet width length Wp equal to or larger than the upper threshold value b (e.g., large size).

Then, the process proceeds to step S4, and in step S4, the controller 64 calculates and determines the marker conveyance time tm by Formula 1 using the sheet width length Wp and the marker stacking ratio R as variables. In step S5, the image forming apparatus 1 starts conveying the sheet S. In step S6, the marking device 33A starts inserting the marker 34. Thus, the process is ended.

On the other hand, if the marker backside exposure mode is set to ON and the mode is executable (YES in step S2), the process proceeds to step S7, and in step S7, the controller 64 calculates and determines the marker conveyance time tm by Formula 2 described above using the sheet width length Wp as a variable. Then, in step S5, the image forming apparatus 1 starts conveying the sheet S. In step S6, the marking device 33A starts inserting the marker 34. Thus, the process is ended.

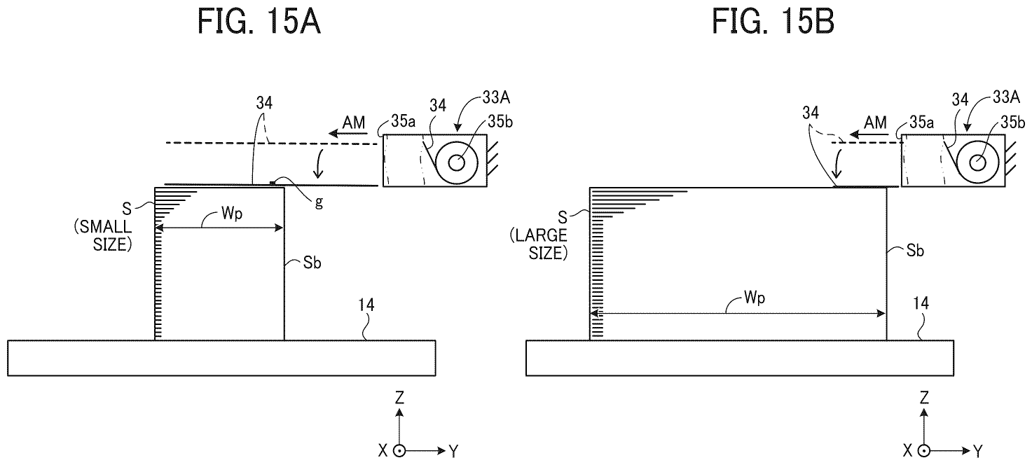

The effect obtained by the marking device 33A described above will be supplementarily described below with reference to FIGS. 15A and 15B. As illustrated in FIG. 15A, in the marking device 33A, the length of the marker 34 inserted to partition the stacked sheet bundles is changed according to the sheet width length Wp of the sheet size stacked on the stacking table 14, so that the center of gravity g of the marker 34 can be reliably placed on the stacked sheet bundle. This configuration prevents the marker 34 from falling in the case of the sheet S of a small size.

As illustrated in FIG. 15B, the consumption amount of the marker 34 can be reduced in the case of the sheet S of a large size. As described above, the marking device 33A can prevent the marker from falling when the sheet width length is small, and can reduce the consumption amount of the marker when the sheet width length is large.

In the above-described embodiments, the image forming apparatus 1 is an inkjet recording apparatus that forms full-color images, but an image forming apparatus is not limited thereto. The present disclosure is also applicable to a copier, a facsimile machine, and a multifunction peripheral (MFP).

In the above-described embodiments, the sheet S is mentioned as a recording medium on which an image is formed, and the sheet S is not limited a recording paper but also includes thick paper, a postcard, a rolled sheet, an envelope, plain paper, thin paper, coated paper, art paper, tracing paper, an overhead projector transparency (OHP sheet or OHP film), a resin film, and any other sheet-shaped material on which an image can be formed.

The above embodiments of the present disclosure described above substantially include, for example, the following aspects.

### Aspect 1

A marking device conveys a marker to sequentially place the marker on an uppermost sheet of sheets stacked on a stacking table so that sheet bundles are partitioned at predetermined intervals in a sheet width length orthogonal to a sheet conveyance length of the sheet bundles stacked on the stacking table. The marking device includes a sheet size data storage that stores sheet conveyance length data and sheet width length data. The marking device acquires the sheet width length data from the sheet size data storage and delays a marker conveyance end timing according to the acquired sheet width length data.

In other words, a marking device includes a marker conveyor, a memory, and circuitry. The marker conveyor conveys a marker in a first direction from a start timing to an end timing and places the marker on an uppermost sheet of each sheet bundles each having a predetermined number of sheets conveyed in a second direction orthogonal to the first direction and stacked on a stacking table in a third direction orthogonal to the first direction and the second direction. Each of the sheets has a width in the first direction and a length in the second direction. The memory stores the width. The circuitry acquires the width from the memory and controls the marker conveyor to delay or advance the end timing according to the width acquired from the memory.

With this configuration, according to Aspect 1, the marking device can be provided which can optimize the marker length according to the sheet width length of the sheet size.

### Aspect 2

In the marking device according to Aspect 1, the marker conveyance end timing is delayed as the sheet width length data is longer, and is advanced as the sheet width length data is shorter.

In other words, the circuitry delays the end timing when the sheets have a first width and advances the end timing when the sheets have a second width larger than the first width.

With this configuration, according to Aspect 2, the sheet having the small sheet width length does not fall from the uppermost sheet stacked on the stacking table, and the consumption amount of the marker can be reduced in the case of the sheet having the large sheet width length.

### Aspect 3

In the marking device according to Aspect 2, the marker conveyance end timing is calculated by a function using the sheet width length as a variable. The marker conveyance end timing is controlled so that a center of gravity of the marker is constantly positioned above the stacked sheet bundle stacked on the uppermost surface of the stacking table.

In other words, the circuitry calculates the end timing defined by a function of the width as a variable and controls the marker conveyor to position a center of gravity of the marker to be inside an area of the uppermost sheet in the first direction.

With this configuration, according to Aspect 3, when the marker lands, the marker is placed on the stacked sheet.

### Aspect 4

In the marking device according to Aspect 3, a derivation formula of the marker conveyance end timing has a marker stacking ratio as a variable. The marker stacking ratio is calculated to be larger as the sheet width length is larger, and the marker conveyance end timing is calculated to be larger as the marker stacking ratio is larger.

In other words, the circuitry sets a marker stacking ratio that is a ratio of a length of a portion of the marker inside the area of the uppermost sheet to an entire length of the marker in the first direction, increases the maker stacking ratio with an increase in the width of the sheets, and delays the end timing with an increase in the marker stacking ratio.

With this configuration, according to Aspect 4, even when the marker length is too short, the marker can be reliably placed on the stacked sheet without falling due to disturbance such as wind pressure until the marker lands.

### Aspect 5

In the marking device according to Aspect 2, the marker conveyance end timing is divided into multiple groups according to a range of the sheet width length. A value is provided in advance for each of the groups, and the marker conveyance end timing is automatically applied according to the sheet width length.

In other words, the memory stores multiple groups of the end timing and a range of the width, and the circuitry controls the marker conveyor to delay or advance the end timing according to the range of the width acquired from the memory.

With this configuration, according to Aspect 5, any desired marker length can be set according to the sheet width length without using a derivation formula.

### Aspect 6

The marking device according to Aspect 1, further includes an on/off setting item of a marker backside exposure mode and a setting item of a marker backside exposure amount. When the marker backside exposure mode is on, the marker conveyance end timing is calculated according to the sheet width length data and the set marker backside exposure amount.

In other words, the circuitry controls the marker conveyor to delay the end timing to extend the marker from one side beyond another side of the sheet bundle in the first direction as a marker backside exposure mode and calculates the end timing to convey the marker for a length beyond the width in the first direction in the marker backside exposure mode.

With this configuration, according to Aspect 6, the marker can be exposed to the opposite side of the marking device by a desired amount according to the sheet width length.

### Aspect 7

An image forming apparatus includes the marking device according to any one of Aspects 1 to 6.

In other words, an image forming apparatus includes the marking device according to any one of Aspects 1 to 6, an image forming device to form images on the sheets, and a conveyor to convey the sheets from the image forming device to the stacking table in the second direction.

With this configuration, according to Aspect 7, a marking device or an image forming apparatus can be provided which can optimize the marker length according to the sheet width length of the sheet size.

As described above, according to one aspect of the present disclosure, a marking device can be provided which optimizes a marker length according to a sheet width size.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A marking device comprising:
a marker conveyor to:
convey a marker in a first direction from a start timing to an end timing; and
place the marker on an uppermost sheet of each sheet bundles each having a predetermined number of sheets:
conveyed in a second direction orthogonal to the first direction; and
stacked on a stacking table in a third direction orthogonal to the first direction and the second direction, each of the sheets having a width in the first direction and a length in the second direction;
a memory to store the width; and
circuitry configured to:
acquire the width from the memory; and
control the marker conveyor to delay or advance the end timing according to the width acquired from the memory.

2. The marking device according to claim 1,
wherein the circuitry is further configured to:
delay the end timing when the sheets have a first width; and
advance the end timing when the sheets have a second width larger than the first width.

3. The marking device according to claim 2,
wherein the circuitry is further configured to:
calculate the end timing defined by a function of the width as a variable; and
control the marker conveyor to position a center of gravity of the marker to be inside an area of the uppermost sheet in the first direction.

4. The marking device according to claim 3,
wherein the circuitry is further configured to:
set a marker stacking ratio that is a ratio of a length of a portion of the marker inside the area of the uppermost sheet to an entire length of the marker in the first direction;
increase the maker stacking ratio with an increase in the width of the sheets; and
delay the end timing with an increase in the marker stacking ratio.

5. The marking device according to claim 2,
wherein the memory stores multiple groups of the end timing and a range of the width, and
the circuitry is further configured to control the marker conveyor to delay or advance the end timing according to the range of the width acquired from the memory.

6. The marking device according to claim 1,
wherein the circuitry is further configured to:
control the marker conveyor to delay the end timing to extend the marker from one side beyond another side of the sheet bundle in the first direction as a marker backside exposure mode; and
calculate the end timing to convey the marker for a length beyond the width in the first direction in the marker backside exposure mode.

7. An image forming apparatus comprising:
the marking device according to claim 1;
an image forming device to form images on the sheets; and
a conveyor to convey the sheets from the image forming device to the stacking table in the second direction.
